(19) United States
(12) Patent Application Publication
(10) Pub. No.: US 2009/0167931 A1
(43) Pub. Date: Jul. 2, 2009

(54) IMAGING DEVICE

(76) Inventors: Kunihiko Kanai, Nagano (JP); Naoki Mizutani, Nagano (JP)

Correspondence Address: Pamela Crocker, Patent Legal Staff;Eastman Kodak Company, 343 State Street, Rochester, NY, 14650-2201, US

(21) Appl. No.: 12/110,556

(22) Filed: Apr. 28, 2008

(30) Foreign Application Priority Data
Dec. 27, 2007 (JP) 2007-335470

(51) Int. Cl. G03B 13/32; H04N 5/232

(52) U.S. Cl. 348/349; 396/89; 348/E05.042

(57) ABSTRACT

An imaging device is provided to perform focus control by detecting a facial part of a person, or to prevent focus shift to a background other than a human subject even when no facial part is detected, and to ensure that a subject desired by a user is photographed. A timer is started by a half-pressing operation of a release button. When a facial part of a person is detected, photographing is performed by focusing on the facial part. When no facial part is detected, the lengths of a time period T2 elapsed since the half-pressing operation of the release button and a threshold time period T3 are compared, and focus methods are switched according to the comparison result. For example, when the release button is full-pressed in one pressing operation, multi-AF is performed to focus on the human subject.

### CROSS REFERENCE TO RELATED APPLICATIONS

This application claims priority to Japanese Patent Application No. 2007-335470 filed on Dec. 27, 2007, which is incorporated herein by reference in its entirety.

### FIELD OF THE INVENTION

The present invention relates to an imaging device, and more particularly to focus control.

### BACKGROUND OF THE INVENTION

Various autofocus (AF) methods have been proposed in the past including multi-AF which focuses on the nearest object by measuring distances at multiple points; center-spot AF which focuses at the center of the screen; and face AF which detects a facial part in a subject image to focus on the detected facial part. These AF methods are appropriately switched to photograph subject images.

FIG. 6 shows an example of conventional method of switching among focus methods. First, face detection is performed to detect a facial part in a subject image (S101). Because face detection techniques are well-known, their detailed explanation is omitted. When a facial part is detected, AF is performed to track the detected facial part (S102). On the other hand, when no facial part is detected, multi-point AF with nearest point priority (in other words, multi-AF) is performed (S103). When a user full-presses a release button (S2) in this state (S104), the subject is fixed (S105) and photographing is performed (S106). It should be noted that in a two stroke release button that enables a half-pressing operation and a full-pressing operation, a half-pressing operation is often called “S1”, while a full-pressing operation is called “S2”.

In such a switching method, because AF is performed to track a facial part when detected, an image of a moving person can be reliably photographed. When no facial part is detected, multi-AF is performed to prevent a so called “central out-of-focus” state in which the focus is adjusted on the background behind a person, and the person becomes out-of-focus.

FIG. 7 shows another conventional method of switching among focus methods. First, face detection is performed to detect a facial part in a subject image (S201). When a facial part is detected, AF is performed to track the detected facial part (S202). On the other hand, when no facial part is detected, it is determined whether or not a user has half-pressed (S1) the release button (S203). When it is determined that the user has not half-pressed the release button, that is when the user has full-pressed (S2) the release button in one pressing operation, center-spot AF which focuses on the center of the screen is performed (S204). When it is determined that the user has half-pressed the release button, the center of the screen is fixed as the subject (S205) to perform AF by tracking the fixed area (S206). When the user full-presses (S2) the release button in this state, the subject is fixed (S208) and photographing is performed (S209).

In such a switching method, when no facial part is detected, focus is locked on a subject in the center of the screen in order to enable photographing of the subject without missing a photo-opportunity.

JP 2001-304855 A discloses a technique of controlling focus by detecting a facial part in a subject, while JP 2006-337388 A discloses a technique of, in response to a full-pressing operation in one pressing operation, canceling focus processes to enable immediate photographing. Further, JP 2007-232793 A discloses controlling focus in a method with high focus accuracy in response to a half-pressing operation, while controlling focus in a method with high photographing speed in response to a full-pressing operation in one pressing operation.

In the method shown in FIG. 6, no tracking function other than face tracking is provided. Therefore, when photographing a moving subject, there is a risk of missing a photo-opportunity. Further, because multi-AF is performed, no photographing is possible other than the one with priority on a subject at close range.

In the method shown in FIG. 7, even though a moving subject can be reliably photographed by AF which enables tracking of the area fixed by a half-pressing operation, there is a risk of generating a background-focused state because the center of the screen is fixed as a subject. Even though such a background-focused state can be prevented by performing multi-AF as shown in FIG. 6, photographing is performed with priority only on a subject at close range as described above. Therefore, there is an issue that a subject desired by a user cannot be selected.

### SUMMARY OF THE INVENTION

An object of the present invention is to provide a device which enables reliable photographing of a subject desired by a user by controlling focus on a facial part when detected while preventing a central out-of-focus state even when no facial part is detected.

According to an aspect of the invention, there is provided an imaging device for imaging a subject image, comprising: a two-stroke release button that enables a half-pressing operation and a full-pressing operation; an imaging element; a detector that detects a facial part in the subject image formed on the imaging element; and a focus controller that performs control to focus on the facial part when the facial part is detected by the detector, while when no facial part is detected by the detector, the focus controller switches among focus methods in accordance with a time period elapsed since the half-pressing operation of the release button in a process from the half-pressing operation to the full-pressing operation.

According to another aspect of the invention, the focus controller performs multi-focus control when the elapsed time period does not reach a threshold time period, while when the elapsed time period becomes equal to or exceeds the threshold time period, the focus controller performs focus control to track a center of a screen.

According to still another aspect of the invention, there is provided an imaging device for imaging a subject image, comprising: a two-stroke release button that enables a half-pressing operation and a full-pressing operation; an imaging element; a detector that detects a facial part in the subject image formed on the imaging element; and a focus controller that performs control to focus on the facial part when the release button is full-pressed in one pressing operation and the facial part is detected by the detector, while when the release button is full-pressed in one pressing operation but no facial part is detected by the detector, the focus controller performs multi-focus control.

According to still another aspect of the invention, the focus controller performs control to focus on the facial part when the release button is half-pressed and then full-pressed after a certain time period and the facial part is detected by the detector, while when the release button is half-pressed and then full-pressed after a certain time period but no facial part is detected by the detector, the focus controller performs control to focus on a center of a screen.

Therefore, according to the present invention, reliable photographing of a subject desired by a user is enabled by performing control to focus on a facial part when detected while preventing a central out-of-focus state even when no facial part is detected. That is, even when no facial part is detected, it is possible to simultaneously achieve prevention of a central out-of-focus state and focusing on a specific subject by switching focus methods in accordance with an operation of the release button.

### BRIEF DESCRIPTION OF THE DRAWINGS

FIG. 1 is an overall configuration diagram of an embodiment of the present invention;

FIG. 2 is a flow chart showing focus control according to an embodiment of the present invention;

FIG. 3 is a diagram explaining switching of focus control according to an embodiment of the present invention;

FIG. 4 is a diagram explaining switching of focus control according to another embodiment of the present invention;

FIG. 5 is a diagram explaining switching of focus control according to still another embodiment of the present invention;

FIG. 6 is a flow chart showing focus control according to a background art; and

FIG. 7 is a flow chart showing focus control according to another background art.

### DETAILED DESCRIPTION OF THE INVENTION

Preferred embodiments of the present invention are described below with reference to the accompanying drawings.

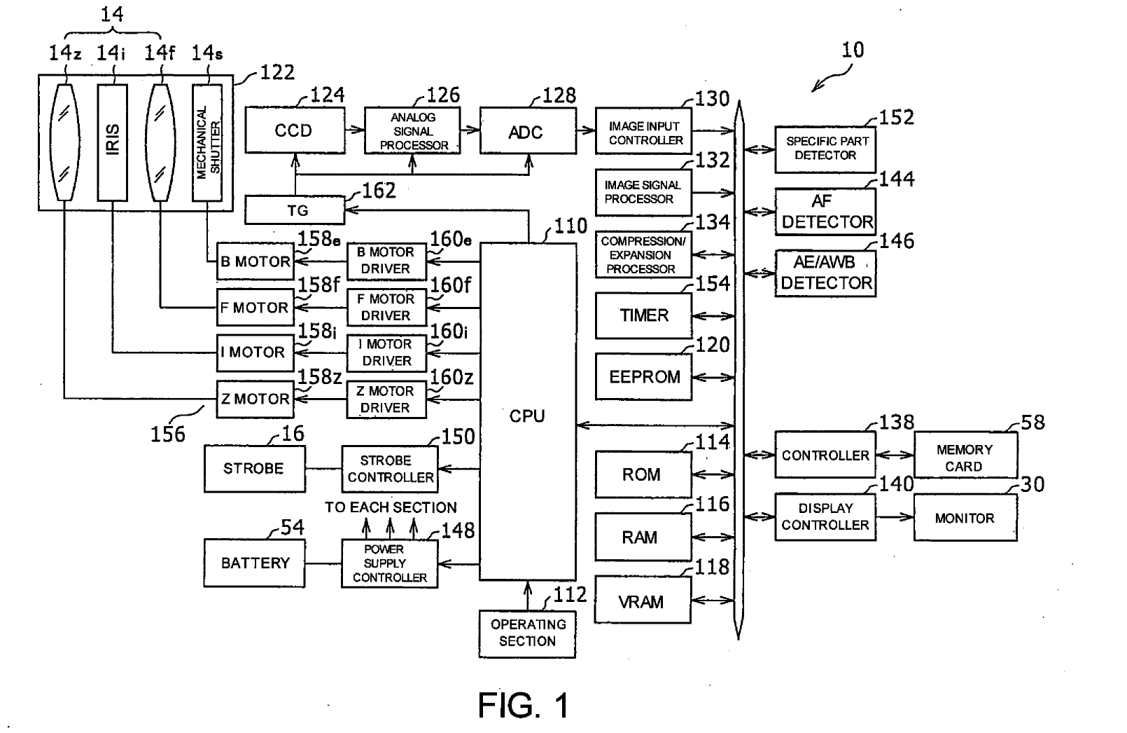

FIG. 1 shows an overall configuration block diagram of a digital camera 10 as an imaging device according to an embodiment of the present invention. Even though the overall configuration is very close to the configuration disclosed, for example, in FIG. 3 of JP 2007-232793 A, the imaging device according to an embodiment of the present invention is characterized by a focus control method performed by a CPU 110.

FIG. 1 shows a photographing optical system 122 including a photographing lens 14, and a mechanical shutter 14s. The photographing lens 14 includes a focus lens 14f, a zoom lens 14z, and an iris 14i. The respective lens and shutter of the photographing optical system 122 are driven by motors 158e, 158f, 158i, 158z, and drivers 160e, 160f, 160i, 160z in accordance with instructions from the CPU 110.

An imaging element 124 converts a subject image formed on the photographing optical system 122 to an electrical signal and outputs the converted signal as an image signal. The imaging element 124 may be made up of a CCD sensor, CMOS sensor, or the like. Accumulated charge is sequentially readout in accordance with a timing signal from a timing generator (TG).

An analog signal processor 126 performs correlative double sampling on the image signal.

An analog digital converter (ADC) 128 converts the image signals of R, G, and B supplied from the analog signal processor 126 to digital signals respectively.

An image input controller 130 accumulates the digital signals from the ADC 128 for one image and stores the accumulated digital signals in a RAM 116.

An image signal processor 132 includes a white balance compensation circuit, a gamma compensation circuit, an edge emphasizing circuit, and a YC generating circuit. The image signal processor 132 performs a predetermined image processing on an input signal to generate image data of Y and C signals.

A compression/expansion processor 134 performs, in accordance with an instruction from the CPU 110, a predetermined compression process on the input image data to generate image data such as JPEG, while the compression/expansion processor 134 performs a predetermined expansion process on the input compressed image data to generate decompressed image data.

A media controller 138 reads and writes data to/from a memory card 58 mounted in a memory card slot 60 in accordance with an instruction from the CPU 110.

A display controller 140 includes an LCD drive circuit. The display controller 140 generates, in accordance with an instruction from the CPU 110, a picture signal to be output to a monitor 30 which may be an LCD, organic EL, or the like.

An AE/AWB detector 146 calculates physical quantities required for automatic exposure (AE) control and automatic white balance (AWB) control in accordance with an instruction from the CPU 110. More specifically, the AE/AWB detector 146 detects the luminance of a subject from the image signal and determines a light source based on distribution of R/G and B/G. An appropriate exposure determined from the luminance of the subject is used to determine an aperture value, shutter speed, and ISO sensitivity. Further, a gain value for each signal of R, G, and B from the light source is determined.

A power supply controller 148 controls power supply from a battery 54 to each section of the device in accordance with an instruction from the CPU 110. The power supply controller 148 also controls charging to the battery 54.

A strobe controller 150 controls flashing of a strobe 16 in accordance with an instruction from the CPU 110.

A ROM 114 stores a control program executed by the CPU 110 and various types of data.

An EEPROM 120 stores user configurable data.

The RAM 116 functions as a working memory for the CPU 110.

A VRAM 118 temporarily stores image data to be displayed on the monitor 30.

A specific part detector 152 detects a human facial part in input image data in accordance with an instruction from the CPU 110. Various methods may be used for detecting a facial part. For example, by extracting a skin color portion from image data and by obtaining a matching ratio between the extracted skin color image and a human facial part template, an area with a high matching ratio can be considered to be a possible facial part. It may be further judged whether or not the possible facial part is a face by extracting eyes in the possible facial part.

An AF detector 144 measures distance to be used for performing AF by switching AF methods to any one of face AF which tracks a facial part while focusing on a detected facial part; multi-AF; and area tracking AF which tracks a subject in the center of the screen while focusing on the subject. As a method for measuring distance, either one of a contrast detection method and a phase detection method may be used. A number of measurement points used for the multi-AF may be any number of three, five, seven, or more.

A timer 154 measures a time period between a half-pressing operation (S1) and a full-pressing operation (S2).

In the above-described configuration, when a human facial part is detected by the specific part detector 152, the CPU 110 performs AF to focus on the detected facial part. That is, face AF is used as a basic focus control. When no facial part is detected by the specific part detector 152, the CPU 110 performs AF by switching focus methods based on a time period elapsed since the half-pressing operation in a process from the half-pressing operation (S1) to the full-pressing operation (S2), measured by the timer 154. More specifically, the length of a time period T2 elapsed since the half-pressing operation (S1) is compared to the length of a threshold time period T3, and AF is performed according to the comparison result of the time lengths.

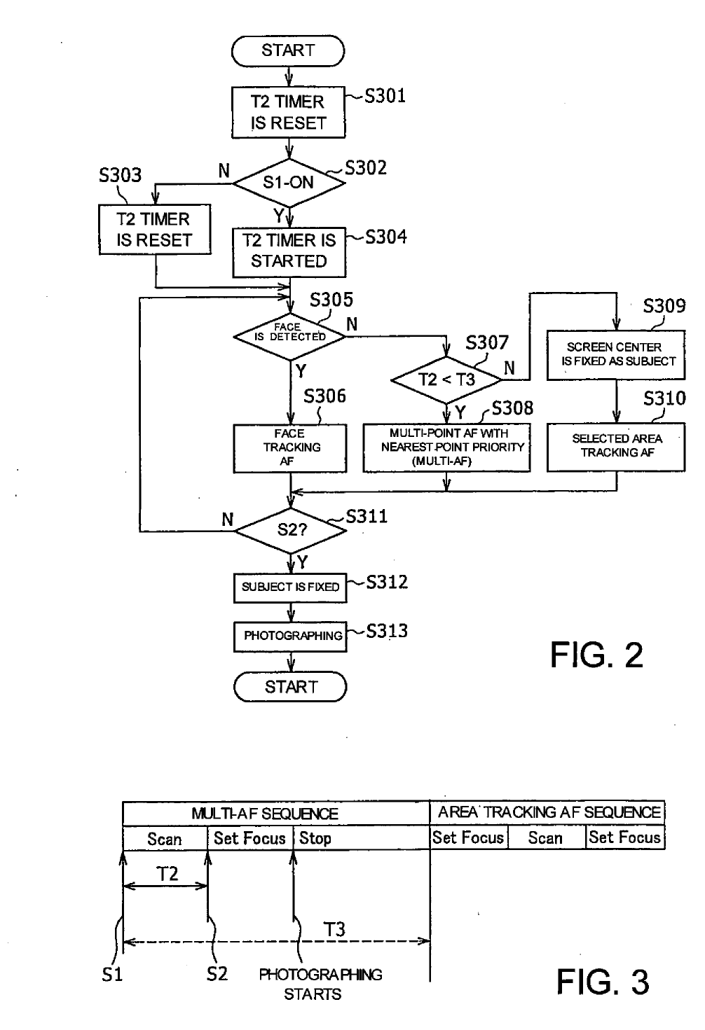

FIG. 2 shows a focus control method according to an embodiment of the present invention. First, the CPU 110 resets time of the timer 154 (T2 timer) (S301). Then, the CPU 110 determines whether or not a user has half-pressed (S1) the release button (S302). When the CPU 110 determines that the user has half-pressed (S1) the release button, the CPU 110 starts the timer 154 (S304).

Next, the CPU 110 determines whether or not a facial part has been detected by the specific part detector 152 (S305). When a facial part has been detected, the CPU 110 performs AF to track the detected facial part (S306). That is, when the facial part moves, the measurement point is also moved to track the movement of the facial part. Pattern matching may be used for tracking. When the user full-presses (S2) the release button in this state (S311), the subject is fixed (S312) and photographing is performed (S313).

On the other hand, when no facial part is detected by the specific part detector 152, the lengths of a time period measured by the timer 154, that is the time period T2 elapsed since a half-pressing operation, and the threshold time period T3 are compared (S307). The threshold time period T3 may be stored in the ROM 114 in advance. When the comparison result of the time lengths shows “elapsed time period T2<threshold time T3” (the elapsed time period T2 has not reached to the threshold time period T3), multi-AF is performed to carry out multipoint AF with nearest point priority (S308). During this process, the monitor 30 may display an area frame indicating a current focus area. When the user full-presses (S2) the release button in this state (S311), the subject is fixed (S312) and photographing is performed (S313). Because multi-AF is performed for photographing, the central out-of-focus state can be prevented.

When the comparison result of the time lengths of the time period T2 elapsed since a half-pressing operation and the threshold time T3 shows “elapsed time period T2≧threshold time period T3” (the elapsed time period T2 is equal to or more than the threshold time period T3), center-spot AF in which the center of the screen is fixed as the subject is performed instead of the multi-AF (S309) to perform AF to track the fixed area (S310). This method is hereinafter called “area tracking AF”. When the user full-presses (S2) the release button in this state (S311), the subject is fixed (S312) and photographing is performed (S313). Because the center of the screen is fixed as the subject to be tracked, it is possible to photograph the subject desired by the user.

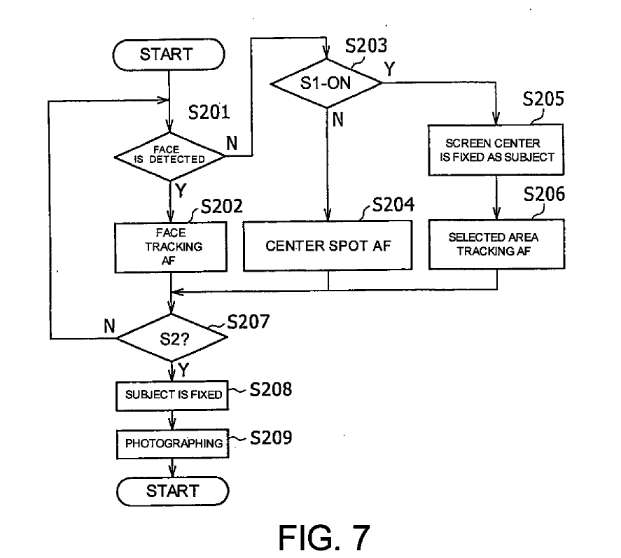

As shown above, in a focus control method according to an embodiment of the present invention, when a time period elapsed since a half-pressing operation (S1) is short, more specifically, when a user full-presses the release button in one pressing operation, multi-AF is performed in consideration of high degree of urgency of a photo-opportunity in order to enable focusing on a person to prevent the central out-of-focus state. On the other hand, when the time period elapsed since a half-pressing operation is relatively long, it is assumed that a user desires to track a specific subject. Accordingly, area tracking AF is performed to track the subject desired by the user while enabling photographing without missing a photo-opportunity. Comparing between the method shown in FIG. 6 and an embodiment of the present invention, in the method shown in FIG. 6, because the nearest object is given the priority for the focus, the subject desired by the user may not be photographed. On the contrary, in the method according to an embodiment of the present invention, the subject desired by the user can be photographed. In an embodiment of the present invention, when the time period elapsed since a half-pressing operation (S1) is relatively long, it is assumed that the user wishes to photograph a specific subject, and further that the desired subject is positioned at the center of the screen. Therefore, the center of the screen is fixed as the subject, and AF is performed to track the subject. Comparing between the method shown in FIG. 7 and a method according to an embodiment of the present invention, in the method shown in FIG. 7, because focus is controlled to be always on the center of the screen, the central out-of-focus state is often generated. On the contrary, in the method according to an embodiment of the present invention, when the time period elapsed since a half-pressing operation (S1) is relatively short, multi-AF is performed to reliably prevent the central out-of-focus state. Naturally, when a user wishes to perform AF to track a specific subject instead of performing multi-AF, the user is likely to fully press (S2) the release button after a half-pressing operation (S1) instead of fully pressing the release button in one pressing operation.

It should be noted that in the present embodiment, as will be apparent from processes of S305, S306, S311, S312, and S313 in FIG. 2, even when a user full-presses the release button in one pressing operation, AF is performed to focus on a facial part as long as a facial part is detected, while multi-AF is performed when no facial part is detected.

FIGS. 3, 4, and 5 show relationships, in embodiments of the present invention, between a time period elapsed since a half-pressing operation (S1) and a focus control method. Each drawing shows process sequences of multi-AF and area tracking AF. The multi-AF sequence includes each step of scanning at respective measurement points; setting focus; and fixing the focus. The area tracking AF includes each step of setting focus (to focus on a subject at the center of the screen); scanning required to perform tracking; and setting focus again. The threshold time T3 is set longer than the time period required to fix the focus in multi-AF, that is, T3=t+α wherein “t” indicates a time period required to fix the focus while “α” indicates a constant time period.

FIG. 3 shows a process in a case where a time period between a half-pressing operation (S1) and a full-pressing operation (S2) is short, that is T2<T3, such as when a user full-presses the release button in one pressing operation and a full-pressing operation (S2) is made before the focus is set in multi-AF. In this case, the focus is set in multi-AF and photographing starts after the focus is fixed. Because photographing starts after the focus is fixed, a certain time period is required before photographing actually starts after a user full-presses (S2) the release button.

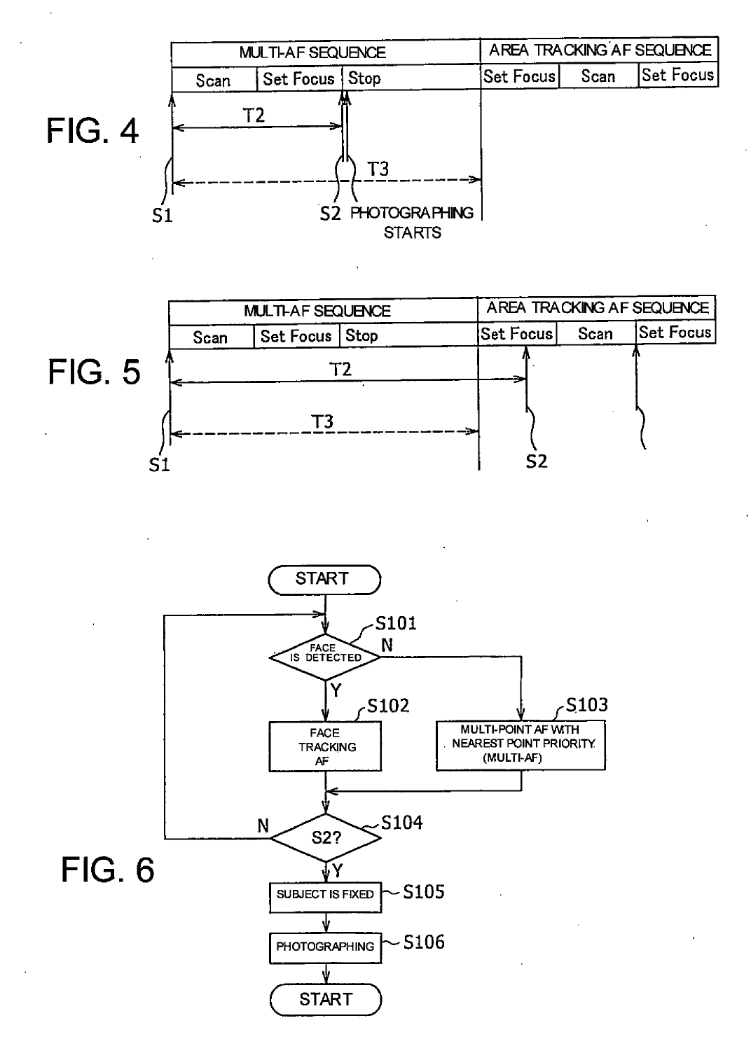

FIG. 4 shows another process also in a case where T2<T3, even though the time period from a half-pressing operation (S1) to a full-pressing operation (S2) is longer than the process shown in FIG. 3. In this case, Multi-AF is used to set the focus, and furthermore, a full-pressing operation (S2) is made after the focus is fixed. Because the focus has been fixed when the full-pressing operation (S2) is made, photographing actually starts immediately after the user full-presses (S2) the release button.

FIG. 5 shows a process in a case where a time period elapsed between a half-pressing operation (S1) and a full-pressing operation (S2) is long, that is T2≧T3. The focus control method is switched from multi-AF to area tracking AF. When a full-pressing operation (S2) is made before completion of focus setting, photographing starts after the focus setting is completed and tracking is achieved when the scanning is completed.

While embodiments of the present invention are described above, the present invention is not limited to these embodiments, and a wide variety of variations are possible.

For example, while the threshold time T3 is stored as a fixed value in the ROM 114 in the above described embodiments, the threshold time T3 may be stored in the EEPROM 120 as a variable time period configurable by a user. Because the threshold value T3 functions as a time delay before multi-AF is switched to area tracking AF, operational comfort may be improved by enabling a user to configure the threshold time T3.

Further, while an AF method is switched to area tracking AF when T2≧T3 in the above described embodiments, the area tracking AF may be canceled to switch back to multi-AF when no subject is detected at the center of the screen, that is, when the distance data obtained from the distance measurement is longer than a certain distance. This is because, even though area tracking AF is performed on the assumption that, when T2≧T3, the subject desired by the user is positioned at the center of the screen, such an assumption may not always be correct, and there is a risk that the subject desired by the user may be out of the center of the screen.

Still further, in the above described embodiments, when a facial part is detected, AF for tracking the facial part is performed. However, photographing may start, even when a facial part is detected, without tracking the facial part when a full-pressing operation is made in one pressing operation. In other words, even when a facial part is detected, it may be determined whether or not a full-pressing operation is made in one pressing operation. When the full-pressing operation is made in one pressing operation, focus may be set on the detected facial part to perform photographing after fixing the set focus, while when the full-pressing operation is not made in one pressing operation, photographing may be performed by tracking the facial part.

### PARTS LIST

10 digital camera
14 photographing lens
14f focus lens
14i iris
14s mechanical shutter
14z zoom lens
16 strobe
30 monitor
54 battery
58 memory card
60 memory card slot
110 CPU
114 ROM
116 RAM
118 VRAM
120 EEPROM
122 optical system
124 imaging element
126 analog signal processor
128 analog digital converter
130 image input controller
132 image signal processor
134 compression/expansion processor
138 media controller
140 display controller
144 AF detector
146 AE/AWB detector
148 power supply controller
150 strobe controller
152 part detector
154 timer
158e motor
158f motor
158i motor
158z motor
160e driver
160f driver
160i driver
160z driver

What is claimed is:

1. An imaging device for imaging a subject image, comprising:
a two-stroke release button that enables a half-pressing operation and a full-pressing operation;
an imaging element;
a detector that detects a facial part in the subject image formed on the imaging element; and
a focus controller that performs control to focus on the facial part when the facial part is detected by the detector, while when no facial part is detected by the detector, the focus controller switches among focus methods in accordance with a time period elapsed since the half-pressing operation of the release button in a process from the half-pressing operation to the full-pressing operation.

2. The imaging device according to claim 1, wherein the focus controller performs multi-focus control when the elapsed time period does not reach a threshold time period, while when the elapsed time period becomes equal to or exceeds the threshold time period, the focus controller performs focus control to track a center of a screen.

3. An imaging device for imaging a subject image, comprising:
a two-stroke release button that enables a half-pressing operation and a full-pressing operation;
an imaging element;
a detector that detects a facial part in the subject image formed on the imaging element; and
a focus controller that performs control to focus on the facial part when the release button is full-pressed in one pressing operation and the facial part is detected by the detector, while when the release button is full-pressed in one pressing operation but no facial part is detected by the detector, the focus controller performs multi-focus control.

4. The imaging device according to claim 3, wherein the focus controller performs control to focus on the facial part when the release button is half-pressed and then full-pressed after a certain time period and the facial part is detected by the detector, while when the release button is half-pressed and then full-pressed after a certain time period but no facial part is detected by the detector, the focus controller performs control to focus on a center of a screen.

5. The imaging device according to claim 2, wherein the imaging device further includes a monitor that displays a frame showing a focus target area in the multi-focus control.
